(19) United States
(12) Patent Application Publication
(10) Pub. No.: US 2023/0400855 A1
(43) Pub. Date: Dec. 14, 2023

(54) SYSTEM AND METHOD FOR LAND MANAGEMENT USING A REMOTE MONITORING NETWORK

(71) Applicant: Taylor Montgomery Mantick, Prescott, AZ (US)

(72) Inventor: Taylor Montgomery Mantick, Prescott, AZ (US)

(21) Appl. No.: 17/838,338

(22) Filed: Jun. 13, 2022

(51) Int. Cl. G05D 1/00; G05D 1/10; B64C 39/02; B64D 47/00; B64F 1/22; B64D 25/00

(52) U.S. Cl. CPC G05D 1/0094; G05D 1/104; B64C 39/024; B64D 47/00; B64F 1/222; B64D 25/00; B64C 2201/08; B64C 2201/146; B64C 2201/122

(57) ABSTRACT

A system and method for land management using a remote monitoring network including a plurality of sensor operation towers that utilize renewably sustained stationary and mobile sensors, including vertical takeoff and landing remotely piloted aircraft (VTOL RPA), that are autonomously launched, recovered, stored, and maintained by the sensor operation towers to autonomously and remotely acquire environmental, electro-optic, infrared, and light detection and ranging sensor data which is then organized via computer programs encoded on a storage medium and then communicated via a network in a manner that updates and enhances the short-term and long-term situational awareness and decision making capabilities of modern land management entities and thereby aids in land management practices.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

This invention relates generally to land management, and more specifically, to techniques for facilitating land management using a remote monitoring network.

### 2. Description of the Related Art

Prior public and private land management entities including the agricultural, forestry, and security industries, have employed a variety of systems and methods to acquire data to aid in property management operations, including land utilization and upkeep. The rate, resolution, and scale of the data needed may be determined by the entity's specific land applications. In some instances, the data may be used to combat the effects of short-term and/or long-term hazards threatening land asset integrity. However, the current systems and methods are quite limiting and do not acquire the amount of data in real time needed to efficiently manage the land properly. One example are wildfires. Wildfires don't start out covering hundreds of acres, however they are able to grow and spread over time because the entity in charge doesn't know they are there. The instant invention solves this problem and reduces or eliminates the disastrous effects of wildfires by granting a user the ability to rapidly access, inspect, and gain situational awareness at any location on their property, no matter how remote, minimizing the amount of time a potential wildfire has to build and spread.

Accordingly, the instant invention overcomes the disadvantages associated with the prior art, by providing a system and method for land management using a remote monitoring network including a plurality of sensor operation towers that utilize renewably sustained stationary and mobile sensors to autonomously and remotely acquire environmental, electro-optic, infrared, and light detection and ranging sensor data which is then organized via computer programs encoded on a storage medium and communicated via a network in a manner that updates and enhances the short-term and long-term situational awareness and decision making capabilities of modern land management entities and thereby aids in land management practices.

### BRIEF SUMMARY OF THE INVENTION

In view of the foregoing disadvantages inherent in the known types of systems and methods for land management in the prior art, the present invention provides an improved system and method for land management. As such, the general purpose of the present invention, which will be described subsequently in greater detail, is to provide a system and method for land management using a remote monitoring network including a plurality of sensor operation towers that utilize renewably sustained stationary and mobile sensors, including vertical takeoff and landing remotely piloted aircraft (VTOL RPA), that are autonomously launched, recovered, stored, and maintained by the sensor operation towers to autonomously and remotely acquire environmental, electro-optic, infrared, and light detection and ranging sensor data which is then organized via computer programs encoded on a storage medium and then communicated via a network in a manner that updates and enhances the short-term and long-term situational awareness and decision making capabilities of modern land management entities and thereby aids in land management practices.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

The figures which accompany the written portion of this specification illustrate embodiments according to the teachings of the present invention.

FIG. 1 shows a view of the system and method for land management using a remote monitoring network according to the preferred embodiment of the present invention.

FIG. 2 shows a front perspective view of a mobile sensor within a sensor operation tower according to the preferred embodiment of the present invention of FIG. 1.

FIG. 3 shows a top perspective view of a mobile sensor within a sensor operation tower according to the preferred embodiment of the present invention of FIG. 1.

FIG. 4 shows a front perspective view of a mobile sensor extending outwardly via an extendable rail from a sensor operation tower according to the preferred embodiment of the present invention of FIG. 1.

FIG. 5 shows a perspective view of a mobile sensor according to the preferred embodiment of the present invention of FIG. 1

The various embodiments of the present invention will hereinafter be described in conjunction with the appended drawings.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

The instant invention provides a remote monitoring network comprised of interconnected stationary and mobile sensors capable of providing four-dimensional data generation intended to aid in conservation and security efforts across large and small geographic areas. The network's hardware is comprised of specially adapted and designed remote sensing equipment that includes the autonomously functioning Drone Operation Towers (DOTs) and the vertical takeoff and landing remotely piloted aircraft (VTOL RPAs). The software includes the desktop and mobile application that allows the user to remotely access and interface with these elements. The software also includes data processing features that autonomously acquire, analyze, and present pertinent data to the user.

A Drone Operation Tower (DOT) hosts a suite of weather instruments, deploys, recovers, and stores the VTOL RPA, and communicates its data via a 5G connection. The RPA is a fixed-wing, VTOL aircraft with electro-optic, infrared, and light detection and ranging (LIDAR) sensors that will autonomously investigate auto-generated and/or user-specified points of interest (POIs) as well as perform routine mapping/scanning operations. The VTOL RPA will communicate its data and be autonomously or manually controlled via a 5G connection. The desktop and mobile applications enable the user to remotely interface with the DOTs and RPAs and will present the user, in real-time, with the status of all the DOTs and RPAs that comprise their network, as well as the data these assets obtain. The system further includes computers and mobile devices for running the application and processing the network's data.

The Remote Monitoring Network (RMN) is a technology that leverages the functionality of remotely operated sensor systems to provide end-users with advanced situational awareness and data collection capabilities across large or small geographic areas around the clock.

The Remote Monitoring Network (RMN) is a technology that leverages the functionality of remotely operated sensor systems to provide end-users with advanced situational awareness and data collection capabilities across large or small geographic areas. The RMN is designed to provide land management entities with the ability to visually assess/inspect any location of their property on demand—no matter how remote. While not actively investigating specified points of interest, the RMN also generates data from routine scanning and mapping missions of the user's land asset(s).

The network consists, in part, of a series of interconnected 5G drone operation towers (DOTs) that are distributed across the user's property. These autonomous, ruggedized, weather-proof drone operation towers are solar powered, host a suite of weather instruments, and house/operate a fixed-wing vertical takeoff and landing remotely piloted aircraft (VTOL RPA). Because they operate in a fully autonomous, self-contained and self-sustained manner, the DOTs can be placed (and left) anywhere on the user's land—ideally in remote and/or hard to access locations where response times would be extensive.

The VTOL RPAs are equipped with electro-optic (EO), infrared (IR), and light detection and ranging (LIDAR) sensors that offer the user a multitude of information. One way the RMN helps land management entities monitor and protect their asset(s) is by using these VTOL RPAs to actively investigate points of interest (POIs) anywhere on their property. POIs can be auto generated by the RMN's software, or they can be manually created by the end-user.

The RPA is housed in a ruggedized, weather-proof operations tower that doubles as the control station and provides the aircraft with data connectivity, a renewable power source, and a clear launching/landing area. The RPA is kept safe, prepared, and in the field, ready for when it is needed.

During its down time, while its not actively investigating POIs for the user, the other way the RMN can help land management entities is by using the RPA to conduct autonomous scanning/mapping missions to continually develop a LIDAR point cloud (LPC) of the user's terrain. From this data, products like digital elevation models, digital surface models, watershed models, vegetation density, available fuel models, etc. can be generated for the user's benefit.

The scale of the hardware that carries out the Remote Monitoring Network's tasks is small enough to be electrically operated and renewably sustained. The software that interconnects these systems allows the network's tasks to be carried out autonomously, with the data getting fed back to the user for handling.

Data is generated at a frequency that continually enhances, expands, and refines the user's understanding of their property over time. It can also be generated rapidly enough to help protect their asset(s) from time-sensitive hazards and threats.

The Remote Monitoring Network is a technology that enables the end-user to have advanced, real-time data collection and situational awareness capabilities across large geographical areas. The Remote Monitoring Network can be utilized by large scale land management entities to help combat the effects of wildfires. This technology directly addresses an issue that large-scale land management organizations are currently facing during their battle against these natural disasters. The Remote Monitoring Network is a tool that allows users to have an in-depth understanding of their property and a sense of situational awareness that is finally capable of matching the scale of their managed land(s) and operations.

Wildfires don't start out covering hundreds of acres; they are able to grow and spread over time because we don't know they're there. The Remote Monitoring Network hopes to solve this problem and reduce (or eliminate) the disastrous effects of wildfires by granting a user the ability to rapidly access, inspect, and gain situational awareness at any location on their property, no matter how remote, minimizing the amount of time a potential fire has to build and spread.

While not actively investigating points of interest for the user, the Remote Monitoring Network also generates a profound amount of data on the user's land/property that can be utilized to support conservation and research efforts seeking to protect communities, critical infrastructure, habitats, recreational areas, and watersheds from potential wildfire damages. This data is acquired autonomously and is continuously supplied to the user for their benefit.

A Drone Operation Tower (DOT) autonomously deploys a vertical takeoff and landing remotely piloted aircraft (VTOL RPA) that, based on the RPA's endurance/range, has a circular area of coverage around the DOT. By deploying the proper number of DOTs with the appropriate amount of overlap, coverage of an entire geographical area can be obtained. Because the DOTs are ruggedized, self-sufficient, and weatherproof, they can be placed and left anywhere in the field to conduct their autonomous drone operations. Because the VTOL RPAs fly, they are able to patrol adverse, difficult, inaccessible, and remote terrain, and have the added benefit of being able to transit to points of interest in a straight line at a constant speed, and takeoff and land without a runway. By being in the field, ready, and able to rapidly investigate points of interest, the response time to locate, assess, and respond to potential wildfires is drastically decreased, which reduces the amount of time a fire has to spread which greatly reduces the cost, complexity, and danger of response operations.

The RMN can be adapted to a number of applications. In tandem with wildfires, forest services could also utilize the network for search and rescue efforts. The grid scanning and waypoint investigation features combined with thermal optics could greatly enhance the effectiveness of rescue operations. It could also be used by agricultural entities to assess the health of their crops and plan land maintenance. It could also be used by ranchers to monitor herds as opposed to using helicopters and horses. It could also be used by transportation agencies to monitor highways, railroads, and waterways. And it could also be used by energy companies to remotely monitor large expanses of powerlines. The Remote Monitoring Network has the potential to increase the efficiency and effectiveness of a number of modern-day applications—some of which greatly benefit the public.

The following is an example of operations in a National Forest. First, the user will begin by defining the geographical location of the property they want remotely monitored. After the appropriate number of DOTs are installed and connected, autonomous drone operations and data collection will begin. Once in the field and deployed, the four (4) LG four-hundred watt (400 W) solar panels on the roof of the DOT will begin charging the station's 70 kWh battery bank (enough to conduct autonomous drone operations for at least three (3) days without sunlight) through the DOT's solar charge regulator. Once the forty-eight volt (48 V) DC power from the battery bank has been ran through a 3500 W inverter and converted to one-hundred twenty volt (120 V) AC, it is ready to run the electronics. The DOT will act as a field weather station, generating surface weather data in accordance with National Weather Service (NWS) operational standards. This data can be used by both the end user and the country's various weather agencies to help monitor and identify conditions of fire weather (as well as other climatological phenomena). The DOT's 5G connectivity will allow the data to be shared. While monitoring the weather, the information obtained from the DOT's instrument suite will also be interpreted by the station's computer to evaluate if conditions like wind speed are conducive for safe operation of the VTOL RPA. With a web-scraping program, the station's 5G connectivity allows the computer to pull and evaluate additional data parameters from the internet like cloud level, visibility, etc. If all conditions are satisfied, the DOT will begin its launch procedures.

A preflight inspection of the aircraft will begin. Prior to opening the main hatch, by utilizing the connection created between the VTOL RPA and the launch/recovery platform, telemetry data like battery voltage and payload status will be obtained and verified. Next, an autonomous preflight inspection of the VTOL RPA's control surfaces will be conducted. By utilizing a series of potentiometers, the movement range of the RPA's control surfaces will be evaluated and verified to be functional and within operational tolerances. With this preliminary preflight check completed and passed, the DOT will use integrated USGS terrain elevation data to create a flight plan that will ensure the RPA operates at a safe altitude and at a maximum height of four-hundred feet above ground level (400 ft AGL), in accordance with CFR 14 part 107. In highly variable terrain, the RPA will maintain a flight level of four-hundred feet (400 ft) above the highest point of terrain, while deviating laterally no more than four-hundred feet (400 ft) from that point. With the flight plan created, the DOT's computer will upload the mission to the RPA and verify that it has been accepted. The DOT will then begin the next steps of launching the VTOL RPA. Secondly, high-force electric actuators will open the DOT's main hatch and hold it in the ‘open’ position. After the main hatch is verified as being ‘open’, the linear rail arm system will begin extending, moving the VTOL RPA out and away from the station body. The linear rail arm system takes approximately thirty-seven seconds (37 sec) to fully extend. Once extended, the launch/recovery platform will rotate ninety degrees (90°), orienting the wings of the RPA perpendicular to the extension axis and the nose of the RPA towards the DOT. This orientation gives the VTOL RPA the most clearance for takeoff.

Once in position, the VTOL RPA will undergo calibration procedures and begin acquiring satellites for its GPS. The arms/frame that comprise the linear rail arm system and launch/recovery pad have been designed to include the minimum amount of metals to reduce the potential for magnetic interference during the RPA's compass calibration

After the VTOL RPA has completed its preflight checks and calibration, the user will be notified via an application on their computer or mobile device of the RPA's status, the results of the preflight check, and the intended flight plan. Alongside this information, the software will also pull and display any notice to airmen (NOTAMs), significant meteorological information (SIGMETs), temporary flight restrictions (TFRs), and other flight-critical information for final consideration from the user. The user will then choose to either authorize or deny the flight plan. If approved, the motors will arm. Once verified as spooling, the VTOL RPA will then begin the takeoff portion of its flight by engaging its multiple rotors to first hover, and then gain altitude until it is well and clear of the DOT.

With the aircraft still vertically located above the launch/recovery pad, the VTOL RPA will undergo a final check of its datalink integrity and make a final choice to either perform or abort the flight plan. The user will be notified of the RPA's choice, letting them know that either the flight has commenced, or that the operation has been aborted because there is a characteristic of the flight that needs to be reevaluated. If the flight commences, the RPA will transition to horizontal flight and proceed to the area of operation. The linear rail arm system will then retract and the main hatch door will be closed.

The RPA will be equipped with ‘see and avoid’ hardware and software that will allow it to continually utilize its electro-optical sensor to see, interpret, and react to any variables in its mission environment. The see and avoid technology will allow the RPA to identify and respond to a number of potential hazards like terrain, manned or unmanned air-traffic, and wildlife to ensure safe operation of the aircraft during all phases of flight. Once the VTOL RPA has arrived at its mission location, it will automatically begin its single-grid scan pattern of that section of the forest. Using its downward facing light detection and ranging (LIDAR) sensor, it will acquire highly accurate terrain elevation data that will be used to generate a LIDAR point cloud (LPC) for the user. From this LIDAR point cloud, data like digital elevation models (DEMs), and digital surface models (DSMs) can be created. From these products, additional surface derivatives like slope, aspect, and terrain contours can be generated. These products can benefit a large-scale land management agency by supplementing the data they use to plan and execute maintenance and research operations on their land. For example, the data can be used to keep the road/trail network map products up-to-date and the terrain-elevation data can also be used to check these roads/trails for signs of degradation/erosion.

LIDAR data can also directly be utilized to help prevent potential wildfire threats. By subtracting a digital elevation model (DEM) from a digital surface model (DSM), a composition/volume of the landscape's vegetation can be obtained. Further processing of this ‘vegetation only’ form of the LIDAR point cloud can result in the classification and differentiation of living and dead vegetation. By calculating the volume of the dead vegetation from the data obtained by the RMN, the forest management agency can develop an ‘Available Fuel Model’. An available fuel model could help a land management agency plan forest cleaning efforts and preemptively detect where a fire outbreak could be most harmful. In the event of a fire, the available fuel model, current vegetation model, and real-time surface wind observations from the DOTs will help response teams more accurately predict and respond to a fire's potential growth. An additional benefit of LIDAR is that it is an active sensing system. Because of this, the scans/surveys can be flown day or night, depending on what the user deems most effective.

Once the VTOL RPA has completed its scanning mission, it will return to the DOT. Both the GPS and the ultrasonic time-of-flight triangulation sensor system (UTS) will position the RPA above the launch/recovery platform. The UTS will aid the RPA during its descent and ensure it lands accurately back on the launch/recovery pad. Once the aircraft touches down, it will be secured by the launch/recovery pad's docking mechanism(s). With the aircraft secured back on the pad, the launch/recovery platform will rotate back ninety degrees (90°) and then the linear rail arm system will retract, bringing the RPA back inside the DOT's enclosure. Once the aircraft is inside, the high-force electric actuators will close and seal the main hatch.

While inside after its mission, the VTOL RPA will use the connection created between the launch/recovery pad to recharge its battery and export its scan data and flight logs to the computer. The DOT will notify the user the RPA has returned, what its current status is, and the file name(s) and location(s) of the acquired data. Once the RPA's battery cools down, it will be charged by a lithium-polymer (LiPo) battery charger connected to the DOT's inverter and battery bank. Once fully charged, the aircraft will be put on standby, prepared for its next mission.

The DOTs communicate with the user and each other via a 5G connection and, across multiple stations, the DOT's weather instruments have detected low relative humidity, strong surface winds, unstable air, and identified a drought trend; conditions for critical fire weather.

Through its scans with the VTOL RPAs, supplemented with known data by the user, the RMN's software will identify common ‘areas of use’ that will be saved as points of interest to the network's map. These points of interest can include known campsites, day use areas, frequently visited locations, locations of known active/inactive campfires, and more.

During an RPA's scan, while passing near a known ‘area of use’, the land management professional watching the live electro-optic/infrared (EO/IR) feed notices some vehicles, people, tents, and a campfire. Using their software interface with the RMN, the forest professional selects the location and marks it as ‘active’. With machine learning aided by oversight from the user, the RMN's software is intended to have the capability to begin identifying areas of use and determining if they are occupied/unoccupied autonomously.

With multiple active points of interest across the user's land having been identified from scans throughout the day, at a set time determined by the user, the RMN will begin autonomously allocating DOTs and RPAs to reinvestigate the waypoints and update the user's situational awareness and mental model3 of their land's usage. The assigned DOT's will begin their launch process again by first connecting to the RPA, running through an autonomous preflight check, then generating a mission that travels to the available waypoint(s) and uploading it to the RPA's flight controller.

After completing all primary, secondary, and tertiary preflight checks and procedures, the VTOL RPA, after final approval from the user, launches and begins autonomously executing its mission. The user can choose to continually monitor the RPA's feed or they can allow the RMN's software to autonomously analyze the thermal feed with its fire-detecting algorithm. The algorithm works by first identifying the number of pixels the thermal sensor has assigned a higher than ambient value to. Next, the overall contrast of the sensor's image will be analyzed by measuring the ratio of ‘hot’ and ‘cold’ spots and determining the prevalence of any heat sources. If the algorithm determines that certain parameters are satisfied, the user will be notified that a potential heat source exists at this waypoint. If the user has not been continuously monitoring the video feed, they will be notified by the software via their computer and/or mobile device that their attention is needed.

Arriving on-site at its first ‘active use’ waypoint, the RPA has notified the user that a heat source is present. From viewing the live EO/IR video feed, a forest service professional was able to determine that yes, a fire is present at this location. However, there are also vehicles and people around, the fire is controlled in a pit and is being maintained responsibly. Assuming there are no fire bans in place there is no issue here and the user tells the RPA to continue on to its next waypoint.

The RPA arrives on-site at the next waypoint that, earlier in the day, was known to be ‘active’. The sensors and software undergo the same process and draw the same conclusion; a heat source is present at this location. The user is notified and begins assessing the video feed. The user identifies a campground that shows signs of use and has an organized source of heat in its fire pit, but notices that there are no people, vehicles, tents, equipment, or other immediately evident signs of occupation; the site has been left but the campfire has not been properly extinguished. A prevalent bed of coals combined with high surface winds has reinvigorated the combustion process and relit the fire. The user tells the RPA to begin closely orbiting this location and to stay on-site. With this information, the user is able to notify response teams with the exact coordinates of the fire's location, its current scale, and what effective response measures might entail in terms of equipment and manpower. Because of the network's 5G interconnectivity, the RPA's live EO/IR video feed is also available to the responding ground and air personnel. Crews will be able to access and utilize a live video-feed in tandem with up-to-date map and terrain products when planning their response efforts, and they'll be able to integrate this data into their risk management system(s) which will help them better understand (and subsequently mitigate) the risk(s) associated with their potential operations.

Traveling to the location, a response team was able to put out the fire with only a couple fire extinguishers before it had time to spread. The team also cleared away the nearby brush to reduce the likelihood of an event like this in the future.

Because of its waypoint investigation features and thermal camera, the Remote Monitoring Network could also be applied to search and rescue operations. The user can input the last-known coordinates of a hiker/group and dispatch an RPA to perform a thermal scan pattern over the area, or any other area they wish to search. By utilizing VTOL RPA's that are already located out in the field, larger areas of land can be more effectively scanned with a variety of sensors in a shorter amount of time. The information rescuers could gain from the RMN could allow them to respond more effectively to time-sensitive operations, saving lives and cutting cost and complexity from the efforts.

The RMN could also be utilized to monitor and protect certain areas like critical infrastructure, national monuments, or other historic/significant sites located on the user's land.

The RMN will require intermittent maintenance to keep the DOTs and VTOL RPAs operational. The RPA's battery is estimated to last between three-hundred and five-hundred (300 to 500) charging cycles. At two flights a day, this equates to approximately six (6) months. Preventative inspection and/or maintenance should be performed routinely during this lifetime, as deemed appropriate by the user. It is recommended that the battery and RPA system be inspected (in-person) at least one (1) time a month.

The DOT station's battery bank is expected to last between three-thousand and five-thousand (3000-5000) charging cycles. Experiencing a complete charging cycle as frequently as every two (2) days (at the minimum 3000 charge cycles) equates the battery life to be (at least) approximately sixteen (16) years. Service would be recommended at least every six (6) months.

The sub-systems of the DOT (especially the ones that climate control the enclosure) should be inspected at least every month alongside the battery of the RPA. In all, the RMN's field systems should be inspected every month with an inspection taking roughly thirty (30) minutes per station (for an individual).

A key feature in the autonomous functionality of the Drone Operation Tower (DOT) is the station's ability to safely launch and recover a vertical takeoff and landing remotely piloted aircraft (VTOL RPA).

The DOT accomplishes this by extending the aircraft out and away from the station body by use of an electrically operated linear rail arm system. The linear rail arm system is comprised of two (2) sets of dual pre-aligned shafts mounted to aluminum supports, two (2) pillow block carriage assemblies, two (2) all thread drive axels, two (2) NEMA 23 stepper motors, and the RPA's launch/recovery pad.

The RPA's landing pad is mounted to the smaller linear rail system's pillow block carriage assembly on a support, allowing it to travel the rail system's ten-foot (10 ft) span. The entire small linear rail system is mounted to the larger linear rail system's pillow block carriage assembly, allowing it to travel along its ten-foot (10 ft) span. When retracted, the aircraft is fully stored inside the DOT's weather-proof, ruggedized housing. When fully extended, the linear rail arm system is able to extend the launch/recovery pad and RPA seventy inches (70″) away from the nearest extent of the DOT station.

The loading on the smaller linear rail system, with an RPA at a maximum assumed weight of fifty-five pounds (55 lbs), is approximately six-hundred eighty-four pounds (684 lbs) when fully extended. The dynamic load capacity of the smaller pillow block carriage assembly is nine-hundred twenty pounds (920 lbs). The tensile strength of the 8-32 Grade 1 fasteners used to anchor the shaft assembly is eight-hundred forty pounds (840 lbs), with fifty (50) fasteners total. The loading exerted on the components of the smaller linear rail system are within functional tolerances.

The total weight of the smaller linear rail system assembly, with all required drive components, is estimated to be one-hundred eighty pounds (180 lbs). At an exaggerated full-extension length of twenty feet (20 ft), this places a simplified load of approximately two-thousand four-hundred pounds (2,400 lbs) on the larger linear rail system's pillow block carriage assembly. The dynamic load capacity of the larger carriage assembly is six-thousand eighty pounds (6,080 lbs). The tensile strength of the A325 ASTM bolts anchoring the rail system to the DOT base is one-hundred twenty-thousand pounds (120,000 lbs), with fifty (50) fasteners total. The loading exerted on the components of the larger linear rail system are within functional tolerances.

Because the same NEMA 23 stepper motor is used to drive both the larger and smaller linear rail subsystems that comprise the arm, the heavier of the two loads (the one placed on the larger linear rail system) will be used for the following calculations, with it being assumed the motor will also be able to handle the lesser loads associated with the smaller system.

With a total assembly weight of approximately two-hundred pounds and an estimated coefficient of friction of approximately 0.2μ on the planar recirculating round rail ball bushings, the frictional force that the NEMA 23 motor must overcome is thirty-six pounds (36 lbs). With a thrust load capacity of thirteen pounds (13 lbs) assisted by the mechanical advantage imposed by the pitch and diameter of the all-thread drive axle, the NEMA 23 motor will have a total thrusting load capacity of approximately two-hundred sixty-five pounds (265 lbs). The motor will be capable of overcoming the static and kinetic frictional forces and accelerating the arm system to a maximum extension speed of 14.4 feet/min. With both rail systems traveling at the same time, it will take approximately thirty-seven seconds (37 sec) for the linear rail arm system to fully extend. The loading placed on the NEMA 23/all-thread drive components of the linear rail arm system are within functional tolerances.

The launch/recovery platform will perform several key functions during the deployment and recovery of the RPA. First, the launch/recovery pad hosts the docking mechanisms that secure the aircraft to the platform base. The docking mechanisms will consist of a series of small servo-driven clamps that interface with a 3D-printed plate on the underside of the RPA's fuselage. When the clamps grip the plate and lock down, the RPA will be secured to the launch/recover pad.

The launch/recovery pad also hosts a spring pin connector charging and data transfer interface. This is to charge the RPA's battery and transfer the acquired data to the DOT's computer. The universal serial bus (USB) port from the RPA's flight controller, the USB port from the data storage drive, and the battery leads and balance plug will all be pinned out to a series of spring pin connections that will interface with their respective leads located on the underside of the aircraft's docking plate.

The final function the launch/landing pad serves is hosting the ultrasonic time-of-flight triangulation sensor system that aids in the VTOL RPA's landings. Ultrasonic triangulation will be accomplished by utilizing three (3) synchronized receivers to acquire the time an emitted pulse takes to travel to the RPA then echo back. By knowing the rate of propagation of the emitted pulse and the time it took to reach the RPA and travel back to each receiver, the measurements can be converted to distances. Because the distance between the receivers is known, by utilizing two of the time-of-flight measurements, a triangle is created and the law of cosines will allow us to solve for the angle(s) of the echo's return and subsequently triangulate the position of the aircraft three dimensionally. By iterating this calculation at a defined frequency, the RPA's position will be known over time and the landing assistance/guidance will become four-dimensional.

The force on the larger carriage assembly must provide for the arm to be in equilibrium at an extension length of 18′6″ with an exaggerated load of two-hundred pounds (200 lbs) placed entirely on the furthest extent of the arm is two-thousand sixty-seven 2,467 lbs. The dynamic load capacity of the larger carriage assembly is nearly 2.5 times this amount. With the real-world loading on the carriage block assembly's bearings being slightly less, the torque on the linear rail arm system should be manageable and the concept operationally feasible.

The Remote Monitoring Network (RMN) is a novel technology designed to pose long-standing issues. It utilizes and integrates the known principals of automation, coding, geographic information systems (GIS), networking, remote sensing, and remotely piloted aircraft (RPA)/unmanned aircraft systems (UAS) in a unique and specialized fashion; doing so provides end-users with advanced situational awareness and data collection capabilities across large or small geographic areas.

The RMN, while capable of being applied to a wide range of industries, sees immediate application with large-scale land management entities combating wildfires. The current measures for combatting the effects of this natural disaster are expensive, dangerous, and reactionary. In 2018, the Federal Government spent over three billion ($3B) on fighting wildfires. A single retardant drop from a very large aircraft tanker (VLAT) costs approximately sixty-five thousand dollars ($65,000)—this price excludes the aircraft's approximately twenty-two thousand dollar an hour ($22,000/hr) operating cost. Before 1986, on average, it took about eight (8) days to contain a wildfire. Today, the average wildfire burns for about thirty-seven days.

It is much easier to fight a campfire as opposed to a forest fire; a wildfire only becomes a wildfire because we don't know it is there. The continual monitoring combined with the rapid-response capabilities of the RMN allow a user to have advanced data collection and inspection capabilities anywhere on their property. This enables preemptive detection and action against any potentially time-sensitive threats. The information obtained from the RMN is valuable for short term response operations as well as long-term preventative processes and maintenance.

The RMN is unique, not only because of the ways that it is able to keep its sensors deployed, operational, and secured out in the field, but also because of how it integrates these systems into an intuitive network that generates and presents vast amounts of beneficial data for the user. The RMN is a novel integration of specially adapted technology that is purposefully designed to interact with its environment autonomously, discreetly, and sustainably and then present the information it acquired to the user on a scale, and at a rate, that is proportional to the needs of the modern consumer.

The Drone Operation Towers (DOTs) are designed to be placed and left virtually anywhere in the field. Because of this, they acquire and store their own power. They accomplish this by utilizing solar panels to acquire renewable energy from the sun, which is then stored in a lithium iron phosphate (LiFePO4) battery bank. The DOTs and RPAs utilize a system that operates by turning chemical potential energy into electrical energy. Therefore, the components carry the intrinsic risk of fire. Because of this, the DOTs have been designed to include an effective, reliable, and robust fire suppression system to mitigate the risk posed by any potential electrical fires. For example, the fire suppression system inside the main station body may be an indirect FUREX™ ABC 770 Dry Powder system that is pneumatically operated. The dry chemical powder will be effective for extinguishing any potential lithium-polymer based fires from the DOT's battery bank and/or the RPA's battery, as well as any other electrical fires from the components inside the DOT's main body. The housing may also include fire retardant paint on the interior and exterior surfaces thereof; fire-treated insulation used in the walls and ceilings; and the Electronics may be kept in a fire-proof, weather-proof enclosure. A climate-controlled interior keeps the equipment in an optimal operating temperature range, prolonging component life and reducing the chance of degradation and failure. Both the AC and heater are electrically operated.

The aircraft may have an approximate wingspan of ten feet (10 ft) and an overall length of approximately six feet (6 ft). The VTOL RPA's front two motors will be on servos that allow them to rotate ninety degrees (90°), which this allows the propellers to be used for both vertical takeoff and (after rotating) horizontal flight. Using two (2) of the four (4) propellers to also provide the thrust for horizontal flight saves on weight by minimizing the number of necessary components. Also, the range and endurance will be positively affected because of the propulsive efficiency provided by two motors/props. The other two (2) motors/props utilized during the vertical takeoff/landing portion of the RPA's flight will be ducted fans that are located in the rear fuselage. By making them ducted fans, their propulsive efficiency is increased, and therefore the motors and props can be smaller in size and weight. By recessing the props and motors in the fuselage, parasite drag is minimized. The thermal camera payload is anticipated to be a TELEDYNE FLIR™ Vue Pro R 640©. The electro-optic payload is anticipated to be a gimbal-mounted GoPro™ with >4 k resolution. The LIDAR sensor payload is anticipated to be a VELODYNE LIDAR™ Puck LITE©.

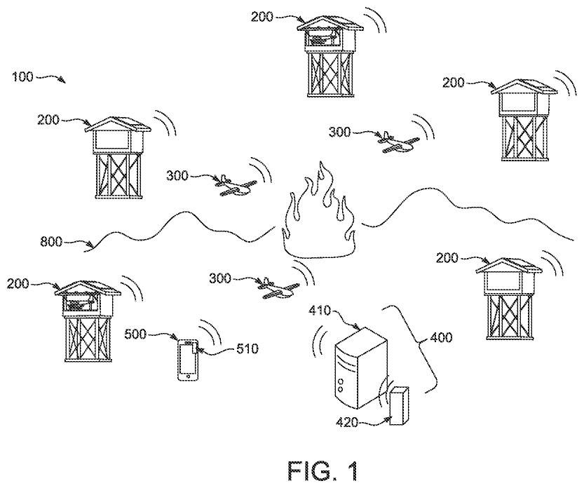

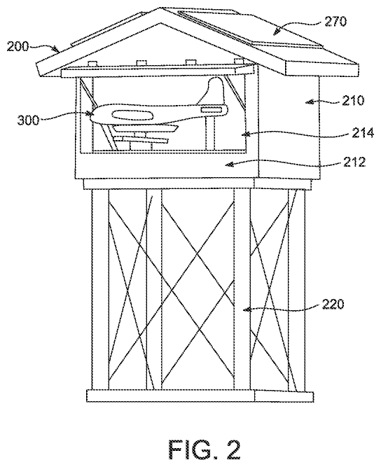

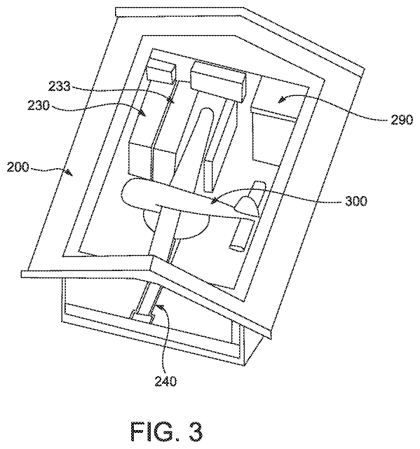

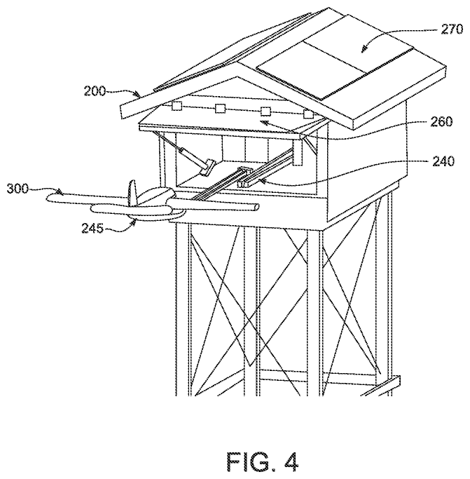

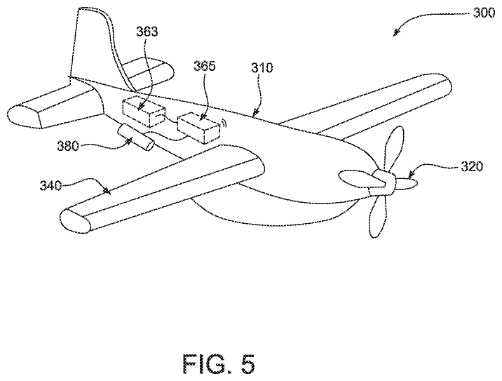

Turning now descriptively to drawing, referring to FIGS. 1-5, the present invention discloses a system and method for land management using a remote monitoring network 100. The method comprises the steps of providing a plurality of sensor operation towers 200, each including a housing 210 including at least one wall 212 forming an enclosure defining an interior volume, wherein one of the at least one wall includes an opening 214 therethrough; and at least one support post 220 attached to the housing and adapted to hold the housing above a ground surface. The housing further including a transceiver 230 attached to the housing and is adapted to receive and send electronic signals; an extendable rail 240 connected to the housing at a proximal end thereof, is located within said interior volume of the housing, and is adapted to extend through the opening of the at least one wall of the housing, wherein the extendable rail 240 may be formed from a plurality of rails telescopically connected to one another; a platform 245 attached to a distal end of the extendable rail and is adapted to releasably hold a mobile sensor 300 on a top surface thereof; at least one electronic servo motor 242 located within the interior volume of the housing and adapted to receive electronic signals from the transceiver, and wherein the at least one electronic servo motor is connected to the extendable rail and is adapted to extend and retract the extendable rail, wherein the extendable rail and the platform are stored within the interior volume of the housing until required for use, and wherein the distal end and the platform thereon are extended outwardly from the interior volume of the housing and through the opening of the at least one wall of the housing. The method further comprises providing a plurality of mobile sensors 300, each including a main body 310 including a hollow interior volume; a propulsion system 320 attached to and is adapted to propel the main body; an airlift system 340 attached to and is adapted to lift the main body through the air; at least one sensor 380 attached to the main body and is adapted to obtain land management data; and a transceiver 365 attached to the main body and is adapted to obtain the data from the at least one sensor and send to a remote electronic communication network 400, wherein each of the plurality of mobile sensors 300 are adapted to be stored upon a respective platform 245 of a respective one of the plurality of sensor operation towers 200 and within the interior volume of the housing 210 until required for use. The method further comprises providing a remote electronic communication network 400 including at least one transceiver 420 adapted to receive data from and send data to the transceiver of each of the plurality of mobile sensors; and at least one computer system 400, each including at least one computer program adapted to process the data sent by the plurality of mobile sensors 300, and provide the data to a control unit 500. The method further comprises providing at least one control unit 500, each including at least one transceiver 510 adapted to receive data from and send data to the transceiver 420 of the computer system of the remote electronic communication network; and at least one computer system 410, each including at least one computer program adapted to receive data from and send data to the plurality of sensor operation towers 200 and the plurality of mobile sensors 300 via the remote electronic communication network 400, wherein the at least one control unit is adapted to control each of the plurality of sensor operation towers, and launch and control each of the plurality of mobile sensors from their respective sensor operation tower. The method further comprises using the at least one control unit 500 to send electronic commands to the plurality of sensor operation towers 200 and the plurality of mobile sensors 300, wherein the commands from the control unit includes a flight path and the length of flight of each of the mobile sensors, and data requirements for each of the plurality of mobile sensors, wherein a chosen number of the plurality of sensor operation towers 200 release a respective mobile sensor 300, wherein the plurality of mobile sensors obtain the required information and send to the control unit via the remote electronic communication network 400 in real time, and wherein the method for land management is adapted to update and enhance situational awareness and decision making capabilities of land management entities and thereby aid in land management practices, including monitoring emergency situations within a geographic location, for example wildfires 700 in a mountain range 800.

The method for land management using a remote monitoring network may further comprise the step of the mobile sensors 300 returning to their respective sensor operation towers 200 upon completion of their flight paths and landing on their respective platforms, wherein after each of the mobile sensors land on their respective platform the respective extendable rail retracts into a stored position within their respective housing 210 along with its platform and mobile sensor.

The mobile sensors 300 may be formed as remotely piloted aircraft and be adapted to be autonomously launched, recovered, stored, and maintained by the sensor operation towers. The remotely piloted aircraft may further include electro-optic, infrared, and light detection and ranging sensors that are adapted to acquire environmental, electro-optic, infrared, and light detection and ranging sensor data. The mobile sensors 300 may also be adapted to generate and provide four-dimensional data comprises positioning and time variables.

The housing 210 of each of the sensor operation towers 200 may further include a pivoting door 260 attached thereto adapted to removably close the opening within the at least one wall when the respective mobile sensor is stored within the interior volume of said housing. As such, the housing is adapted to protect the mobile sensor 300 from the external climate when the door is in a closed configuration. Furthermore, the plurality of sensor operation towers 200 further include a fire suppression system 290 to resist and extinguish fires that may occur therein.

The plurality of sensor operation towers may each further include a battery pack 233 located within its interior volume of its housing and be adapted to provide power to its transceiver and its electronic servo motor, and wherein each of the plurality of mobile sensors may include a battery pack 363 located within its hollow interior of its main body and be adapted to provide power to its propulsion system, its sensors, and its transceiver. Furthermore, the housing of each sensor operation tower may further includes at least one solar panel 270 attached to an outer surface thereof adapted to power its respective battery pack 233 of its sensor operation tower and respective battery pack of its mobile sensor.

The propulsion system may be formed to include at least one rotary propeller although jet propulsion and other propulsion systems and technology may be used. And the airlift system may include at least one aircraft wing, although in some embodiments the propulsion system and the airlift system can be combined as within a helicopter embodiment.

Finally, the method for land management using a remote monitoring network may include any one of the most modern communication technologies, including 5G technology.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed is:

1. A method for land management using a remote monitoring network, comprising the steps of:
providing a plurality of sensor operation towers, each including;
a housing including:
at least one wall;
wherein said at least one wall forms an enclosure defining an interior volume; and
wherein one of said at least one wall includes an opening therethrough; and
at least one support post;
wherein said at least one support post is attached to said housing and adapted to hold said housing above a ground surface;
a transceiver;
wherein said transceiver is attached to said housing and is adapted to receive and send electronic signals;
an extendable rail;
wherein said extendable rail is connected to said housing at a proximal end thereof, is located within said interior volume of said housing, and is adapted to extend through said opening of said at least one wall of said housing;
a platform;
wherein said platform is attached to a distal end of said extendable rail and is adapted to releasably hold a mobile sensor on a top surface thereof;
at least one electronic servo motor;
wherein said at least one electronic servo motor is located within said interior volume of said housing and adapted to receive electronic signals from said transceiver; and
wherein said at least one electronic servo motor is connected to said extendable rail and is adapted to extend and retract said extendable rail;
wherein said extendable rail and said platform are stored within said interior volume of said housing until required for use, wherein said distal end and said platform thereon are extended outwardly from said interior volume of said housing and through said opening of said at least one wall of said housing;
providing a plurality of mobile sensors, each including;
a main body;
wherein said main body includes a hollow interior volume;
a propulsion system;
wherein said propulsion system is attached to and is adapted to propel said main body;
an airlift system;
wherein said airlift system is attached to and is adapted to lift said main body through the air;
at least one sensor;
wherein said at least one sensor is attached to said main body and is adapted to obtain land management data; and
a transceiver;
wherein said transceiver is attached to said main body and is adapted to obtain said data from said at least one sensor and send to a remote electronic communication network;
wherein each of said plurality of mobile sensors are adapted to be stored upon a respective platform of a respective one of said plurality of sensor operation towers and within said interior volume of said housing until required for use;
providing a remote electronic communication network including:
at least one transceiver;
wherein said at least one transceiver is adapted to receive data from and send data to said transceiver of each of said plurality of mobile sensors; and
at least one computer system, each including:
at least one computer program;
wherein said at least one computer program is adapted to process said data sent by said plurality of mobile sensors, and provide said data to a control unit;
providing at least one control unit, each including:
at least one transceiver;
wherein said at least one transceiver is adapted to receive data from and send data to said transceiver of said computer system of said remote electronic communication network; and
at least one computer system, each including:
at least one computer program;
wherein said at least one computer program is adapted to receive data from and send data to said plurality of sensor operation towers and said plurality of mobile sensors via said remote electronic communication network;
wherein said at least one control unit is adapted to control each of said plurality of sensor operation towers, and launch and control each of said plurality of mobile sensors from their respective sensor operation tower;
using said at least one control unit to send electronic commands to said plurality of sensor operation towers and said plurality of mobile sensors;
wherein said commands from said control unit includes a flight path and the length of flight of each of said mobile sensors, and data requirements for each of said plurality of mobile sensors;
wherein a chosen number of said plurality of sensor operation towers release a respective mobile sensor;
wherein said plurality of mobile sensors obtain the required information and send to said control unit via said remote electronic communication network;
wherein said method for land management is adapted to update and enhance situational awareness and decision making capabilities of land management entities and thereby aid in land management practices.

2. The method for land management using a remote monitoring network of claim 1, wherein said mobile sensors are formed as remotely piloted aircraft; wherein said remotely piloted aircraft are adapted to be autonomously launched, recovered, stored, and maintained by said sensor operation towers.

3. The method for land management using a remote monitoring network of claim 2, wherein said remotely piloted aircraft further include electro-optic, infrared, and light detection and ranging sensors that are adapted to acquire environmental, electro-optic, infrared, and light detection and ranging sensor data.

4. The method for land management using a remote monitoring network of claim 1, wherein said plurality of mobile sensors are adapted to generate and provide four-dimensional data; wherein said four-dimensional data comprises positioning and time variables.

5. The method for land management using a remote monitoring network of claim 1, wherein said network includes 5G technology.

6. The method for land management using a remote monitoring network of claim 1, wherein said extendable rail is formed from a plurality of rails telescopically connected to one another.

7. The method for land management using a remote monitoring network of claim 1, wherein said housing of each of said sensor operation towers further includes pivoting door attached thereto adapted to removably close said opening within said at least one wall when said respective mobile sensor is stored within said interior volume of said housing.

8. The method for land management using a remote monitoring network of claim 1, wherein said plurality of mobile sensors obtain the required information and send to said control unit via said remote electronic communication network in real time.

9. The method for land management using a remote monitoring network of claim 1, further comprising the step of:
said mobile sensors return to their respective sensor operation towers upon completion of their flight paths and land on their respective platforms;
wherein after each said mobile sensor lands on their respective platform said respective extendable rail retracts into a stored position within their respective said housing along with its platform and mobile sensor.

10. The method for land management using a remote monitoring network of claim 7, wherein said housing is adapted to protect said mobile sensor from the external climate when said door is in a closed configuration.

11. The method for land management using a remote monitoring network of claim 7, wherein said plurality of sensor operation towers further include a fire suppression system to resist and extinguish fires that may occur therein.

12. The method for land management using a remote monitoring network of claim 7, wherein said propulsion system includes at least one rotary propeller; and said airlift system includes at least one aircraft wing.

13. The method for land management using a remote monitoring network of claim 1, wherein each of said plurality of sensor operation towers includes a battery pack located within its said interior volume of its respective said housing and is adapted to provide power to its said transceiver and its said at least one electronic servo motor; and wherein each said plurality of mobile sensors includes a battery pack located within its said hollow interior of its respective said main body and is adapted to provide power to its said propulsion system, its said at least one sensor, and its said transceiver.

14. The method for land management using a remote monitoring network of claim 13, wherein said housing of each said sensor operation tower further includes at least one solar panel attached to an outer surface thereof and is adapted to power its said respective battery pack of its said sensor operation tower and respective battery pack of its said mobile sensor.
